(19) United States
(12) Patent Application Publication
(10) Pub. No.: US 2016/0266438 A1
(43) Pub. Date: Sep. 15, 2016

(54) TRANSFLECTIVE LIQUID CRYSTAL DISPLAY DEVICE

(71) Applicant: InnoLux Corporation, Miao-Li County (TW)

(72) Inventor: Satoru TAKAHASHI, Miao-Li County (TW)

(21) Appl. No.: 14/645,950

(22) Filed: Mar. 12, 2015

(51) Int. Cl. G02F 1/1335; G02F 1/13363; G02F 1/1337; G02F 1/1343

(52) U.S. Cl. CPC G02F 1/133553; G02F 1/133528; G02F 1/134309; G02F 1/13363; G02F 1/1337; G02F 2001/133541; G02F 2001/133638

(57) ABSTRACT

A transflective liquid crystal display (LCD) device, comprising: a display panel, comprising: a first substrate; a second substrate opposite to the first substrate; a reflective layer disposed on parts of the first substrate; a first electrode disposed on the first substrate and the reflective layer; a second electrode disposed on the first substrate and the reflective layer, and electrically insulating with the first electrode; and a liquid crystal layer disposed between the second substrate and the first electrode as well as the second electrode, wherein the liquid crystal layer has a retardation of 180 nm˜300 nm at a wavelength of 550 nm, and absolute values of twist angles of some of liquid crystal molecules included in the liquid crystal layer are 90°˜135° when the display panel is in an off state.

### BACKGROUND OF THE INVENTION

1. Field of the Invention

The present invention relates to a transflective liquid crystal display (LCD) device and, more particularly, to a transflective LCD device with narrow border region and achromatic white state.

2. Description of Related Art

In recent years, all the display devices are developed toward having small volume, thin thickness and light weight as the display techniques progress. A liquid crystal display (LCD) device is a flat panel display device with a thin thickness, so a conventional cathode ray tube (CRT) display is gradually replaced by the LCD. Especially, the LCD can be applied to various fields. For example, the daily used devices such as cell phones, notebooks, video cameras, cameras, music players, navigation devices, and televisions are equipped with liquid crystal display (LCD) panels.

For the conventional LCD device, a liquid crystal layer is disposed between two electrodes, and voltage is applied onto the electrodes to control the tilt of liquid crystal molecules. Thus, it is possible to control light from a backlight module disposed below the LCD panel to pass or not to pass through the liquid crystal layer, and the purpose of displaying can be achieved. In addition, the purpose of displaying different colors can be achieved through the pixel units.

For the conventional transflective vertical aligned LCD device, the common electrode is disposed on the counter substrate opposite to the thin film transistor (TFT) substrate, and thus a common transfer area is required to electrically connect the common electrode to the circuits on the TFT substrate, resulting in a large border region occurred. In addition, the chromatic white state is usually observed in the conventional transflective vertical aligned LCD device due to wavelength dependency, which is one factor causing the performance thereof decreased.

Therefore, it is desirable to provide a novel transflective LCD device with a narrow border region and an achromatic white state to eliminate the aforementioned problems of the conventional transflective vertical aligned LCD device.

### SUMMARY OF THE INVENTION

The object of the present invention is to provide a transflective liquid crystal display (LCD) device, to reduce the border region and chromatic white state of the conventional transflective vertical aligned LCD device, as well as to solve the problem of small cell gap variation and large temperature dependency of the conventional homogeneous aligned LCD device such as the in-plane switching (IPS) or fringe field switching (FFS) LCD device.

To achieve the object, the transflective LCD device of the present invention comprises: a display panel, comprising: a first substrate; a second substrate opposite to the first substrate; a reflective layer disposed on parts of the first substrate; a first electrode disposed on the first substrate and the reflective layer; a second electrode disposed on the first substrate and the reflective layer, and electrically insulating with the first electrode; and a liquid crystal layer disposed between the first substrate and the second substrate, wherein the liquid crystal layer may have a retardation of 180 nm˜300 nm at a wavelength of 550 nm, and absolute values of twist angles of some of liquid crystal molecules included in the liquid crystal layer may be 90°˜135° when the display panel is in an off state. Herein, the term “off state” indicates that there is no voltage applied to the display panel. On the other hand, the term “on state” used in the present invention indicates that a voltage is applied to the display panel.

In the transflective LCD device of the present invention, both the first and second electrodes, in which one is a common electrode and the other is a pixel electrode, are disposed on the first substrate as a thin film transistor (TFT) substrate and locate at the same side of the liquid crystal layer, so the transflective LCD device of the present invention is a homogeneous aligned LCD device. For the conventional transflective vertical aligned LCD device, the common electrode is disposed on the counter substrate opposite to the TFT substrate, and thus a common transfer area is required to electrically connect the common electrode to the circuits on the TFT substrate. However, since both the first and second electrodes are disposed on the TFT substrate in the transflective LCD device of the present invention, no common transfer area is required, resulting in the border region of the LCD device of the present invention can be reduced.

In addition, for the conventional homogeneous aligned LCD device, small cell gap variation may cause large retardation difference of the liquid crystal layer and the retardation thereof may also depend upon the temperature thereof. However, in the transflective LCD device of the present invention, the liquid crystal layer has specific retardation and the liquid crystal molecules included therein have specific twist angles, and thus the aforementioned problems occurred in the conventional homogeneous aligned LCD device can also be solved.

In the transflective LCD device of the present invention, the display panel may further comprise an insulating layer located between the first electrode and the second electrode to electrically insulating the first electrode and the second electrode. Herein, the shapes of the first and the second electrodes are not particularly limited.

For example, in one aspect of the present invention, one of the first electrode and the second electrode is an electrode with plural strips, i.e. a comb electrode having strips and slits alternately arranged. In this case, preferably, an absolute value of an angle included between the strips and directors of the liquid crystal molecules near the first substrate is 0°˜10°.

In another aspect of the present invention, for example, both the first electrode and the second electrode are electrodes with plural strips, i.e. the aforementioned comb electrode having strips and slits alternately arranged. Herein, the strips of the first electrode and the strips of the second electrode are arranged alternately, i.e. one strip of the first electrode is inserted into one slit of the second electrode, and one strip of the second electrode is inserted into one slit of the first electrode. In this case, preferably, an absolute value of an angle included between the strips and directors of the liquid crystal molecules is 0°˜10°.

In the transflective LCD device of the present invention, the display panel includes a reflective area with the reflective layer disposed on the first substrate and a transmissive area without the reflective layer disposed on the first substrate. Herein, a distance between edges of adjacent strips in the reflective area is different from that between edges of adjacent strips in the transmissive area. Preferably, the distance between edges of adjacent strips in the reflective area is larger than that between edges of adjacent strips in the transmissive area.

Furthermore, in one aspect of the present invention, the transflective LCD device may further comprise a first retarder disposed above the second substrate. In this case, a first alignment layer may further be disposed between the second electrode and the liquid crystal layer, an absolute value of an included angle between a rubbing direction of the first alignment layer and a slow axis of the first retarder is 70°˜110°, and the first retarder has a retardation of 110 nm˜160 nm at a wavelength of 550 nm.

In addition, in another aspect of the present invention, the transflective LCD device may further comprise a first polarizer disposed above the second substrate. In this case, a first alignment layer may also be disposed between the second electrode and the liquid crystal layer, an absolute value of an included angle between a rubbing direction of the first alignment layer and an absorption axis of the first polarizer is 80°˜140°.

In further another aspect of the present invention, the transflective LCD device may further comprise a first polarizer and a first retarder disposed above the second substrate in which the first retarder is disposed between the first polarizer and the second substrate. The features of the first polarizer and the first retarder are the same as those illustrated above, and the descriptions related thereto are not repeated again.

Moreover, the transflective LCD device of the present invention may further comprise a second polarizer and a second retarder disposed under the first substrate in which the second retarder is disposed between the first substrate and the second polarizer, wherein the second polarizer is a linear polarizer, the second retarder is a quarter wave plate with a retardation of 110 nm˜160 nm at a wavelength of 550 nm, and an included angle between a slow axis of the second retarder and an absorption axis of the second polarizer is 45°. Alternatively, in the transflective LCD device of the present invention, the aforementioned second polarizer and the second retarder can be replaced by a wide band circular polarizer disposed under the first substrate.

In the transflective LCD device of the present invention, chiral dopant may further be included in the liquid crystal layer, to maintain the twist angle of the liquid crystal molecules.

Other objects, advantages, and novel features of the invention will become more apparent from the following detailed description when taken in conjunction with the accompanying drawings.

### BRIEF DESCRIPTION OF THE DRAWINGS

FIG. 1 is a cross-sectional view showing a transflective LCD panel according to Embodiment 1 of the present invention;

FIG. 2 is a schematic view showing a transflective LCD device according to Embodiment 1 of the present invention;

FIG. 3 is a graph showing black reflectance of a transflective LCD device according to Embodiment 1 of the present invention;

FIG. 4 is a graph showing white reflectance of a transflective LCD device according to Embodiment 1 of the present invention;

FIG. 5 is an overlapping graph of FIGS. 3 and 4;

FIG. 6 is a schematic view showing the definitions of the angles of the first polarizer and the first retarder in a transflective LCD device according to Embodiment 1 of the present invention;

FIG. 7 is a graph showing a relation between twist angles of liquid crystal molecules and angles of a first polarizer in a transflective LCD device according to Embodiment 1 of the present invention;

FIG. 8 is a graph showing a relation between twist angles of liquid crystal molecules and angles of a first retarder in a transflective LCD device according to Embodiment 1 of the present invention;

FIG. 9 is a cross-sectional view showing a transflective LCD panel according to Embodiment 3 of the present invention;

FIG. 10 is a schematic view showing a first electrode and a second electrode on a first substrate and a reflective layer in a transflective LCD panel according to Embodiment 3 of the present invention;

FIGS. 11A and 11C are graphs showing driving voltages applied to a transflective LCD panel according to Embodiment 3 of the present invention for reflectance and transmittance measurements;

FIGS. 11B and 11D are graphs respectively showing reflectance and transmittance of a transflective LCD panel according to Embodiment 3 of the present invention;

FIG. 12 is a schematic view showing a first electrode on a first substrate and a reflective layer in a transflective LCD panel according to Embodiment 4 of the present invention; and

FIG. 13 is a schematic view showing a first electrode and a second electrode on a first substrate and a reflective layer in a transflective LCD panel according to Embodiment 5 of the present invention.

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

### Embodiment 1

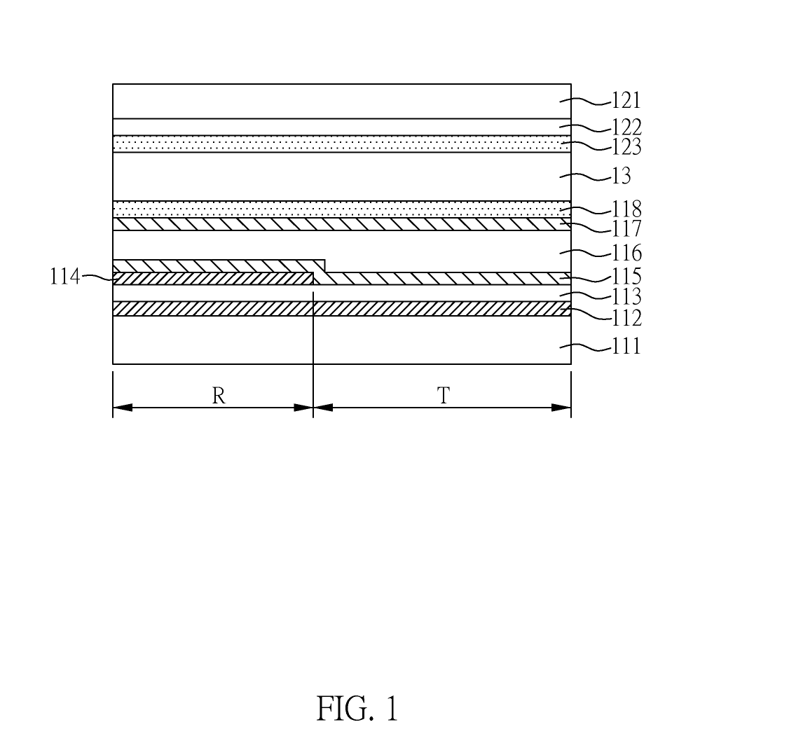

FIG. 1 is a cross-sectional view showing a transflective LCD panel of the present embodiment. The transflective LCD panel of the present embodiment can be prepared by any known process used in the art. Briefly, a first substrate 111 is provided, and thin film transistor (TFT) units (not shown in the figure) and circuits (not shown in the figure) are formed thereon to obtain a wiring and switching layer 112. After the aforementioned steps, a TFT substrate comprising the first substrate 111 and the wiring and switching layer 112 can be obtained. Herein, the first substrate 111 can be a rigid substrate such as a glass substrate, or a flexible substrate such as a thin glass substrate and a plastic substrate. In addition, the known structures and the known preparing method for the TFT units and the circuits can also be applied herein to manufacture the wiring and switching layer 112 in the present embodiment.

After obtaining the TFT substrate, a first insulating layer 113 is formed on the TFT substrate. Then, a reflective layer 114 is disposed on parts of the first substrate 111 as well as the first insulating layer 113 to form a reflective area R, and the region without the reflective layer 114 formed thereon is a transmissive area T. Herein, the reflective layer 114 can be made of any reflector material known in the art, such as metals and alloys.

After forming the reflective layer 114, a first electrode 115 as a common electrode is disposed on both the reflective area R and the transmissive area T on the first substrate 111 and electrically connects to circuits (not shown in the figure) of the wiring and switching layer 112, followed by forming a second insulating layer 116 thereon. Then, a second electrode 117 as a pixel electrode is disposed on both the reflective area R and the transmissive area T on the first substrate 111 and electrically connects to TFT unis (not shown in the figure) of the wiring and switching layer 112, wherein the second electrode 117 electrically insulates with the first electrode 115 by the second insulating layer 116. After forming the second electrode 117, a first alignment layer 118 is formed thereon.

In the present embodiment, the first electrode 115 is served as a common electrode and the second electrode 117 is served as a pixel electrode. However, in other embodiment of the present invention, the first electrode 115 can be served as a pixel electrode, and the second electrode 117 can be served as a common electrode.

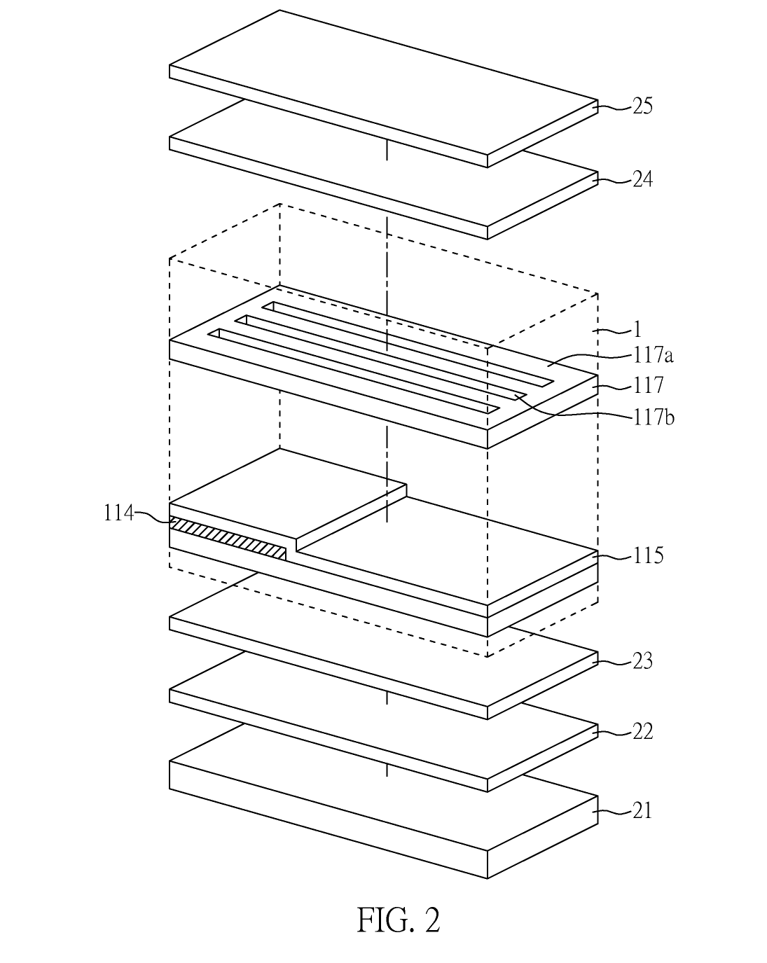

In addition, in the present embodiment, the first electrode 115 is an electrode without patterning, and the second electrode 117 is a comb-shape electrode with plural strips 117a and slits 117b parallel to each other, as shown in FIG. 2. However, the patterns of the first electrode 115 and the second electrode 117 are not limited thereto.

In the transflective LCD panel of the present embodiment, the first insulating layer 113 and the second insulating layer 116 can be respectively made of any insulating material known in the art, such as silicon oxides, silicon nitrides, and silicon oxynitrides. In addition, the first electrode 115 and the second electrode 117 can be made of any transparent electrode materials used in the art, for example transparent conductive oxides such as ITO (indium tin oxide) and IZO (indium zinc oxide).

On the other hand, a second substrate 121 is also provided, followed by forming a color filter layer 122 thereon to obtain a color filter (CF) substrate. Next, a second alignment layer 123 is formed on the color filter layer 122. Herein, the second substrate 121 can also be a rigid substrate such as a glass substrate, or a flexible substrate such as a thin glass substrate and a plastic substrate.

In the transflective LCD panel of the present embodiment, both the first alignment layer 118 and the second alignment layer 123 can be prepared with any material generally used in the art, such as polyimide. In addition, a rubbing process or a photo-alignment process known in the art is applied thereon to provide tilt angles for liquid crystal molecules. In the present embodiment, an absolute value of an angle included between the strips 117a of the second electrode 117 and directors of the liquid crystal molecules near the first substrate is 0°˜10°.

The first substrate 111 and the second substrate 121 are assembled and the first alignment layer 118 faces to the second alignment layer 123. The liquid crystal molecules are disposed in a space therebetween to obtain a liquid crystal layer 13.

After the aforementioned process, the transflective LCD panel of the present embodiment is obtained, which comprises: a first substrate 111; a second substrate 121 opposite to the first substrate 111; a reflective layer 114 disposed on parts of the first substrate 111; a first electrode 115 disposed on the first substrate 111 and the reflective layer 114; a second electrode 117 disposed on the first substrate 111 and the reflective layer 114, and electrically insulating with the first electrode 115 by a second insulating layer 116; and a liquid crystal layer 13 disposed between the second substrate 121 and the first electrode 115 as well as second electrode 117. In addition, a first alignment layer 118 and a second alignment layer 123 further locate on both side of the liquid crystal layer 13 to provide twist angles for the liquid crystal molecules included in the liquid crystal layer 118.

For the conventional transflective vertical aligned LCD panel, the common electrode is disposed on the CF substrate opposite to the TFT substrate with the wiring and switching layer formed thereon, and thus a common transfer area on a border region of the LCD panel is required to electrically connect the common electrode to the circuits on the TFT substrate. However, in the transflective LCD panel of the present embodiment, since both the pixel electrode and the common electrode are disposed on the TFT substrate with the wiring and switching layer, no common transfer area is required and thus the border region of the LCD panel of the present embodiment can further be narrowed.

FIG. 2 is a schematic view showing a transflective LCD device of the present embodiment. The transflective LCD device of the present embodiment comprises: a backlight module 21 disposed below the transflective LCD panel 1 of the present embodiment, wherein the detail structure of the transflective LCD panel 1 is illustrate in FIG. 1. In addition, the transflective LCD device of the present embodiment further comprises: a first retarder 24 and a first polarizer 25 sequentially disposed above the second substrate 121 (as shown in FIG. 1) of the transflective LCD panel 1; and a second retarder 23 and a second polarizer 22 sequentially disposed below the first substrate 111 (as shown in FIG. 1) thereof.

In the present embodiment, both the pixel electrode and the common electrode are disposed on the TFT substrate, and thus the transflective LCD panel of the present embodiment is a transflective homogeneous aligned LCD panel. However, for the conventional homogeneous aligned LCD panel, the liquid crystal molecules used therein has twist angle 0° generally, and the retardation of the liquid crystal layer is greatly influenced by the cell gap and the temperature thereof. For example, the LCD panel has a cell gap of 3.0 μm, if there is a variation of 0.2 μm in the cell gap, and the retardation difference would be about 7%. For another example, the retardation (Δ n) is about 0.127 at 20° C. and 0.134 at 0° C., and the retardation difference between 20° C. and 0° C. would be 5.5%.

Hence, in order to avoid the aforementioned problem, the retardation of the liquid crystal layer and the twist angles of the liquid crystal molecules included therein of the transflective LCD device have to be optimized. In the present embodiment, black and white reflectance simulations are performed to optimize the aforementioned factors of the liquid crystal layer of the present embodiment, wherein the term “black reflectance” refers to the reflectance of the reflective area when the display panel is in an off state, and the term “white reflectance” refers to the reflectance of the reflective area when the display panel is in an on state.

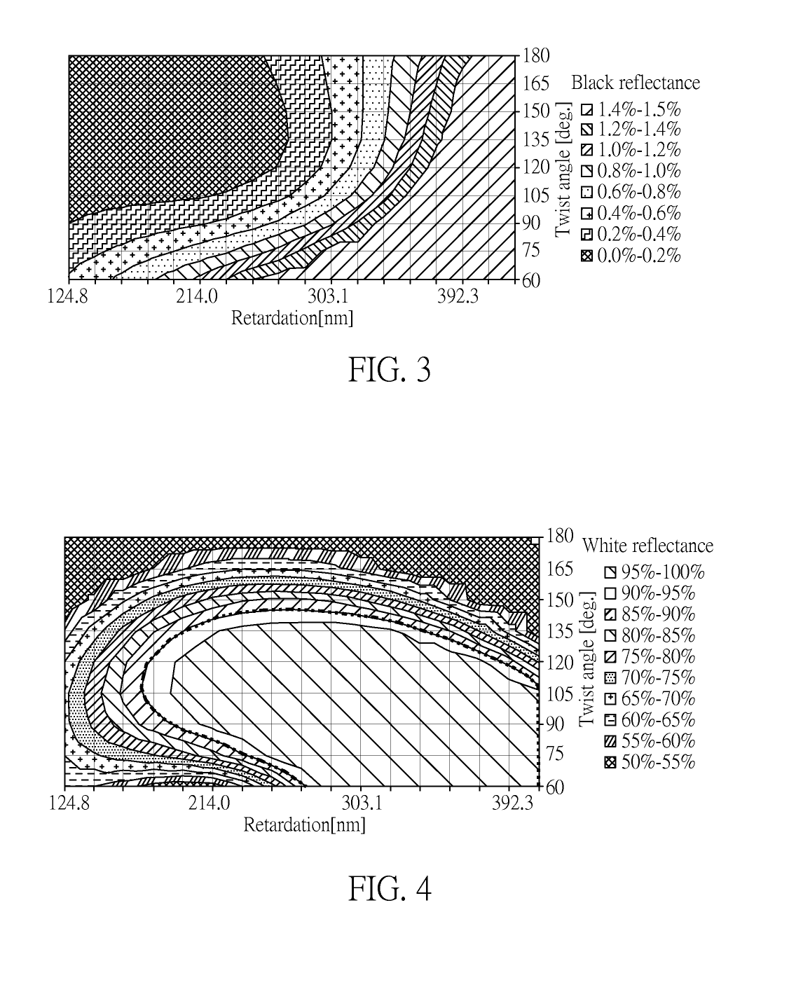

Herein, the transflective LCD panel shown in FIG. 1 is used for the simulations. For the black reflectance simulation, the reflectance of the reflective area R when the display panel is in an off state is determined. First, the display panel equipped with two parallel polarizers is used herein, the optimal polarization state thereof shows the most dark state, and the reflectance in this optimal polarization state is defined as a theoretical minimum reflectance (i.e. black reflectance=0%). Next, by deviating the retardation of the liquid crystal layer at a wavelength of 550 nm, the reflectance of the reflective area R of the display panel equipped with the same two parallel polarizers is further determined. The simulation result about the relation between the deviation of the black reflectance, the retardation and the twist angles are shown in FIG. 3. As shown in FIG. 3, as the retardation decreased and/or the twist angle increased, the reflectance is reduced, indicating a better black reflectance obtained. This result indicates that lower retardation and higher twist angle are preferable to obtain the display panel with best reflectance performance in the off state.

However, the reflectance of the display panel in an on state also has to be considered. For the white reflectance simulation, the reflectance of the reflective area R when the display panel is in an on state is determined. First, the display panel equipped with two parallel polarizers is used herein, the optimal polarization state thereof shows the most dark state, and the reflectance in this optimal polarization state is defined as a theoretical minimum reflectance (i.e. black reflectance=0%). Next, changing the “twist angle in black” −60°, when the display panel in an on state, the LC alignment is approximately to change the twist angle of liquid crystal molecules about 60°. Then the white reflectance can be simulated. The simulation result about the relation between the white reflectance, the retardation and the twist angles are shown in FIG. 4. As shown in FIG. 4, as the retardation increased and/or the twist angle decreased, the reflectance is increased, indicating a better white reflectance obtained. This result indicates that higher retardation and lower twist angle are preferable to obtain the display panel with best reflectance performance in the on state.

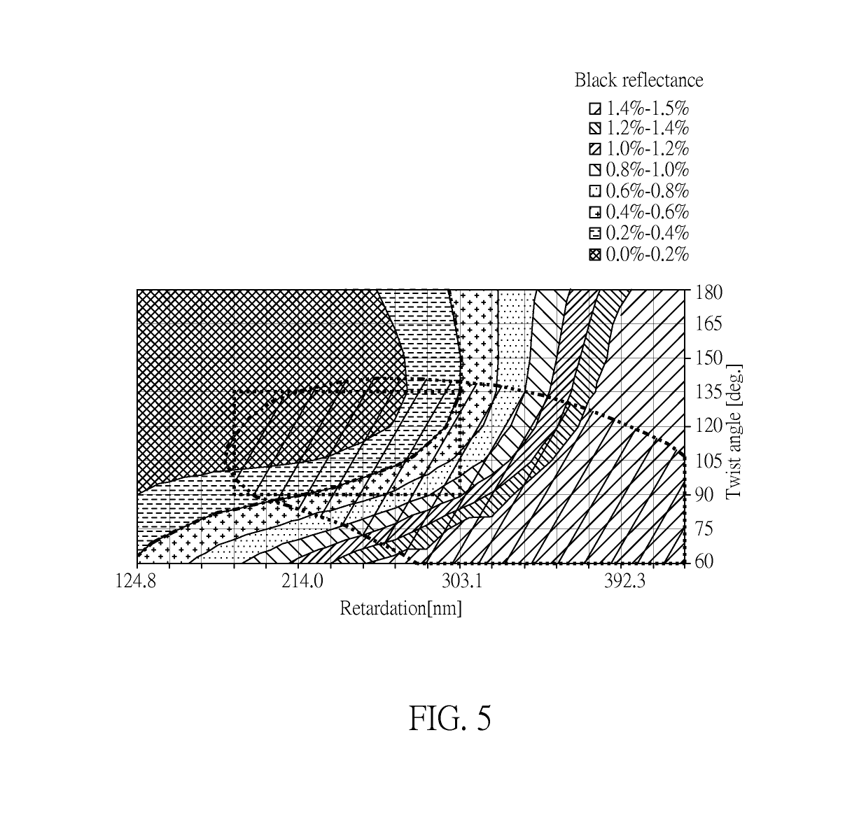

FIG. 5 is an overlapping graph of FIGS. 3 and 4, wherein the rectangle region indicated in dot lines have both good black and white reflectance. Hence, in order to obtain the transflective LCD panel with good performance, the liquid crystal layer thereof has a retardation of 180 nm˜300 nm at a wavelength of 550 nm, and absolute values of twist angles of some of the liquid crystal molecules included in the liquid crystal layer thereof are 90°˜135° when the display panel is in an off state. Herein, for the left hand twisted liquid crystal molecules (i.e. counterclockwise twisted liquid crystal molecules), the twist angles thereof is −90°˜−135°; and for the right hand twisted liquid crystal molecules (i.e. clockwise twisted liquid crystal molecules), the twist angles thereof is 90°˜135°. Herein, in order to maintain the twist angles thereof in the off state, chiral dopant is further added into the liquid crystal layer, wherein examples of the chiral dopant includes, but not limited to, cholesteric liquid crystal material.

In addition, as shown in FIGS. 1 and 2, the rubbing direction of the first alignment layer 118 is determined by the types of the used liquid crystal molecules. For the positive anisotropic dielectric liquid crystal molecules, the included angle between the rubbing direction of the first alignment layer 118 and a longitudinal direction of the strips 117a of the second electrode 117 is in a range from −10° to 10°. For the negative anisotropic dielectric liquid crystal molecules, the included angle between the rubbing direction of the first alignment layer 118 and a longitude direction of the strips 117a of the second electrode 117 is in a range from 80° to 100°.

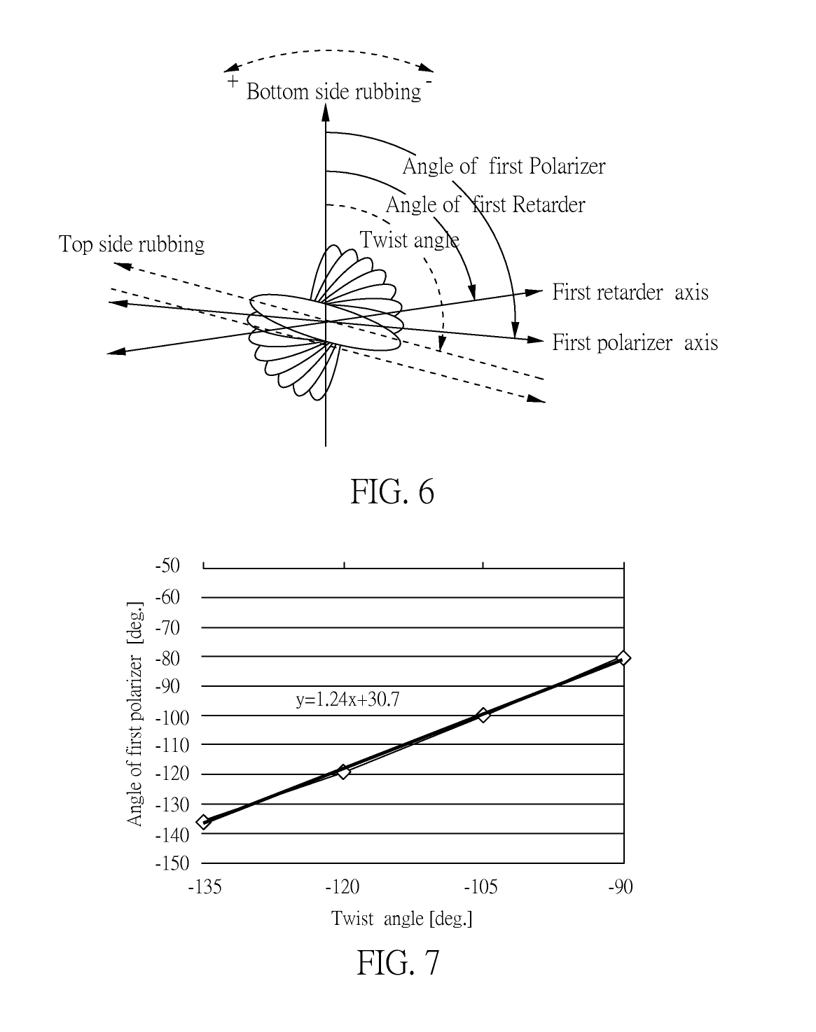

Furthermore, in order to achieve better performance of the transflective LCD device of the present embodiment, the features of the first polarizer 25 and the first retarder 24 shown in FIG. 2 have to be optimized. From the result shown in FIG. 5, which indicates that the absolute values of twist angles of liquid crystal molecules included in the liquid crystal layer thereof preferably are 90°˜135°, the relations between the twist angles of the liquid crystal molecules within the aforementioned range and the angles of the first polarizer 25 as well as the first retarder 24 are determined herein, wherein the definitions of the angles of the first polarizer and the first retarder in the case of applying left hand twisted liquid crystal molecules with twist angles of −90°˜−135° are shown in FIG. 6. In FIG. 6, the first retarder axis in FIG. 6 indicates a slow axis of the first retarder 24 in FIG. 2, the first polarizer axis therein indicates an absorption axis of the first polarizer 25 in FIG. 2, the bottom side rubbing therein indicates a rubbing direction of the first alignment layer 118 in FIG. 1, the top side rubbing therein indicates a rubbing direction of the second alignment layer 123 in FIG. 1, the symbol “−” therein indicates a clockwise angle, and the symbol “+” therein indicates a counterclockwise angle.

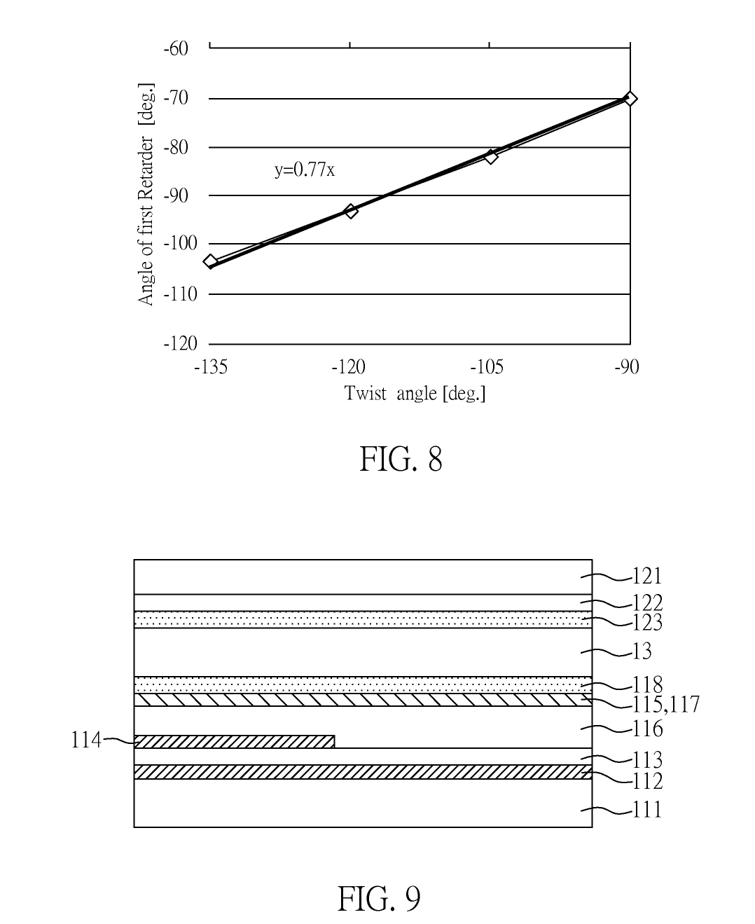

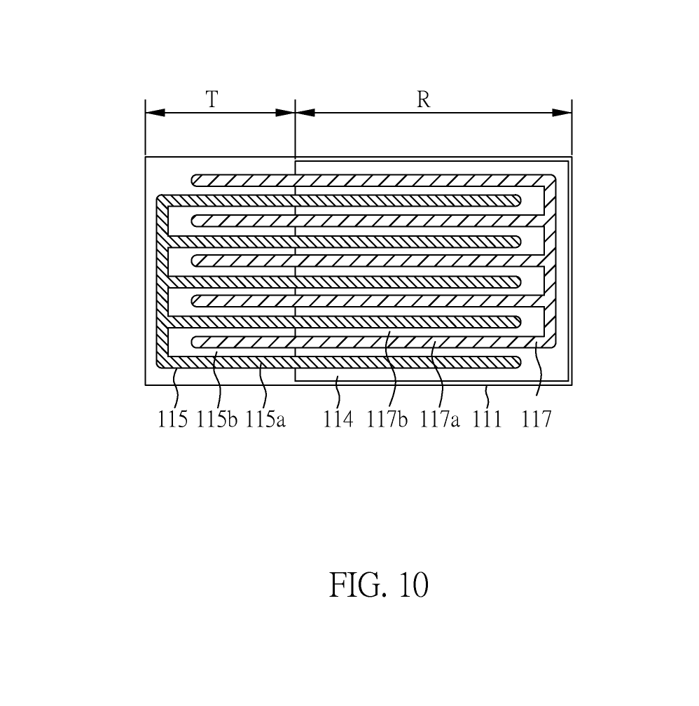

The simulations about the relations between the twist angles of left hand twisted liquid crystal molecules (−90°˜−135° and the angles of the first polarizer 25 as well as the first retarder 24 (as shown in FIG. 2) are performed as follows. Herein, the first retarder 24 can have a retardation of 110 nm˜160 nm at a wavelength of 550 nm, so the retardation of the first retarder 24 is fixed 140 nm at a wavelength of 550 nm in the simulation. Then, the angles of the first polarizer 25 and the first retarder 24 are changed to obtain the simulation results shown in FIGS. 7 and 8.

As shown in FIGS. 7 and 8, in the case that the twist angles of the left hand twisted liquid crystal molecules are −90°˜−135°, the angle of the first polarizer 25 is −80°˜−140°, the angle of the first retarder 24 is −70°˜−110°, and the first retarder 24 has a retardation of 110 nm˜160 nm at a wavelength of 550 nm. In addition, according to the results shown in FIGS. 7 and 8, it can be inferred that the angle of the first polarizer 25 is 80°˜140°, the angle of the first retarder 24 is 70°˜110°, and the first retarder 24 has a retardation of 110 nm˜160 nm at a wavelength of 550 nm, in the case that the twist angles of some of the right hand twisted liquid crystal molecules are 90°˜135°.

In addition, in order to achieve better performance of the transflective LCD device of the present embodiment, the features of the second retarder 23 and the second polarizer 22 shown in FIG. 2 also have to be optimized. In the present embodiment, the second polarizer 22 is a linear polarizer. The second retarder 23 is a quarter wave plate with a retardation of 110 nm˜160 nm at a wavelength of 550 nm, and an included angle between a slow axis of the second retarder 23 and an absorption axis of the second polarizer 22 is 45° or −45°. The second polarizer 22 and the second retarder 23 are combined to form a circular polarizer.

### Embodiment 2

The structures and features of the transflective LCD panel and device of the present embodiment are similar to those illustrated in Embodiment 1, except that the second retarder 23 and the second polarizer 22 shown in FIG. 2 are substituted with a wide band circular polarizer.

### Embodiment 3

As shown in FIG. 9, the structures and features of the transflective LCD panel and device of the present embodiment are similar to those illustrated in Embodiment 1, except that the first electrode 115 is not directly disposed on the reflective layer 114, but disposed on the second insulating layer 116. Thus, both the first electrode 115 and the second electrode 117 are disposed on the second insulating layer 116, and arranged in the same layer.

More specifically, as shown in 10, both the first electrode 115 and the second electrode 117 are comb electrodes with plural strips 115a, 117a and plural slits 115b, 117b, and the strips 115a of the first electrode 115 and the strips 117a of the second electrode 117 are arranged alternately. More specifically, the strips 115a of the first electrode 115 are respectively inserted into the slits 117b of the second electrode 117, and the strips 117a of the second electrode 117 are respectively inserted into the slits 115b of the first electrode 115.

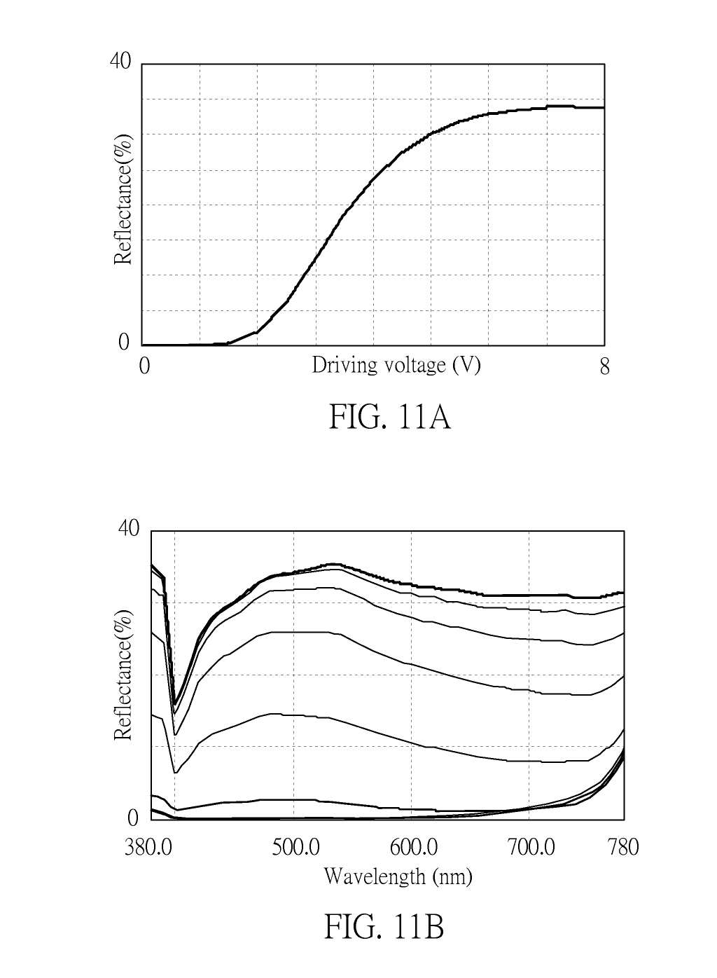

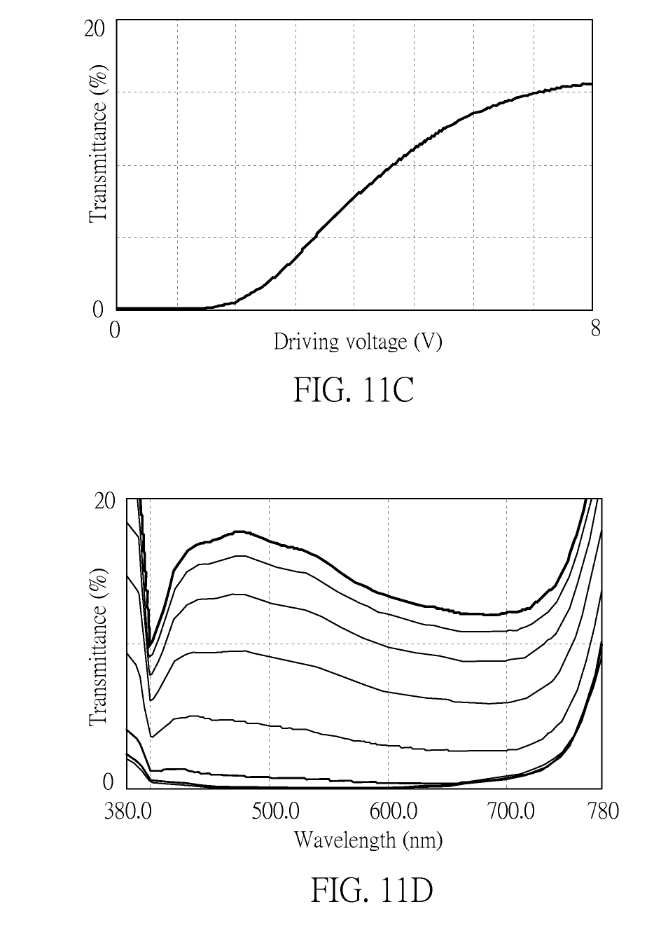

In the present embodiment, the reflectance and the transmittance of the transflective LCD panel at a wavelength of 380 nm˜780 nm are also measured. For the reflectance measurement, as shown in FIG. 11A, increasing driving voltages 0˜8V are applied to the transflective panel of the present embodiment, and the reflectance of the reflective area R is examined to obtain the result. And, as shown in FIG. 11B, eight curves from bottom to top respectively represent eight different voltages (0, 1, 2, 3, 4, 5, 6, 7, 8V) applied to the transflective panel. While in each curve, the result of different wavelengths corresponding to different reflectance of the reflective area R is shown. In addition, for the transmittance measurement, as shown in FIG. 11C, increasing driving voltages 0˜8V are applied to the transflective panel of the present embodiment, and the transmittance of the transmittance area T is examined to obtain the result. And, as shown in FIG. 11D, eight curves from bottom to top respectively represent eight different voltages (0, 1, 2, 3, 4, 5, 6, 7, 8V) applied to the transflective panel. While in each curve, the result of different wavelengths corresponding to different transmittance of the transmissive area T is shown.

For the conventional transflective vertical aligned LCD device, chromatic white state thereof is usually observed due to wavelength dependence. However, from the results shown in FIGS. 11B and 11D, achromatic white state of the LCD panel of the present embodiment can be obtained; and thus the aforementioned chromatic white state can further be eliminated.

### Embodiment 4

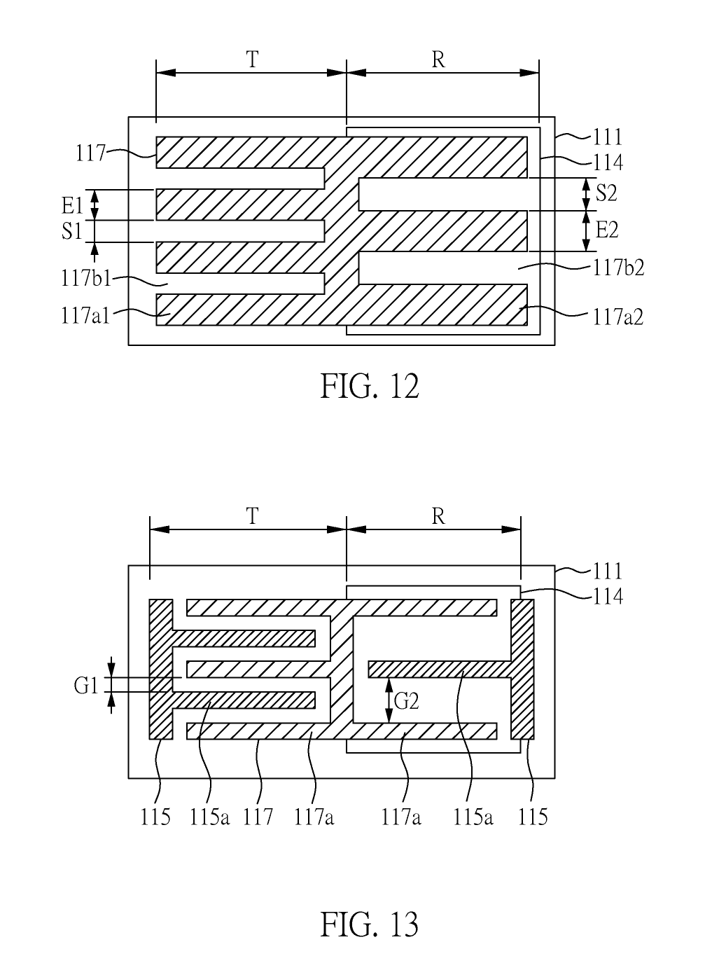

The structures and features of the transflective LCD panel and device of the present embodiment are similar to those illustrated in Embodiment 1, except that the structures of the second electrode 117 in Embodiment 1 and the present embodiment are different. As shown in FIG. 12, the second electrode 117 used in the transflective LCD panel and device of the present embodiment has different sizes of strips and slits in the reflective area R and the transmissive area T. Herein, the distance (i.e. S2 show in the figure) between edges of adjacent strips 117a2 with the reflective layer 114 disposed therebelow (i.e. the reflective area R) is different from and larger than the distance (i.e. S1 shown in the figure) between edges of adjacent strips 117a1 without the reflective layer 114 disposed therebelow (i.e. the transmissive area T). More specifically, the width E1 of the strip 117a1 in the transmissive area T is smaller than the width E2 of the strip 117a2 in the reflective area R; and the width S1 of the slit 117b1 in the transmissive area T is also smaller than the width S2 of the slit 117b2 in the reflective area R.

### Embodiment 5

The structures and features of the transflective LCD panel and device of the present embodiment are similar to those illustrated in Embodiment 3, except that the structures of the first electrode 115 and the second electrode 117 in Embodiment 3 and the present embodiment are different. As shown in FIG. 13, the distance (i.e. G2 show in the figure) between edges of adjacent strips 115a, 117a with the reflective layer 114 disposed therebelow (i.e. the reflective area R) is different from and larger than the distance (i.e. G1 shown in the figure) between edges of adjacent strips 115a, 117a without the reflective layer 114 disposed therebelow (i.e. the transmissive area T).

In the aforementioned embodiment, only one pixel unit is shown in the figures. However, a person skilled in the art understands that plural pixel units are disposed in the transflective LCD panel and device of the present invention.

In addition, a touch panel known in the art can also be used with the transflective LCD device provided by the aforementioned embodiments of the present invention, to provide a touch display device.

Furthermore, the transflective LCD device provided by the aforementioned embodiments of the present invention can be applied to any electronic device for displaying images, such as a watch, a mobile phone, a notebook, a camera, a video camera, a music player, a navigation system, or a television.

Although the present invention has been explained in relation to its preferred embodiment, it is to be understood that many other possible modifications and variations can be made without departing from the spirit and scope of the invention as hereinafter claimed.

What is claimed is:

1. A transflective liquid crystal display (LCD) device, comprising:
a display panel, comprising:
a first substrate;
a second substrate;
a reflective layer disposed on parts of the first substrate;
a first electrode disposed on the first substrate and the reflective layer;
a second electrode disposed on the first substrate and the reflective layer, and electrically insulating with the first electrode; and
a liquid crystal layer disposed between the first substrate and the second substrate,
wherein an absolute values of twist angles of some of liquid crystal molecules included in the liquid crystal layer are 90°˜135° when the display panel is in an off state.

2. The transflective LCD device as claimed in claim 1, wherein the liquid crystal layer has a retardation of 180 nm˜300 nm at a wavelength of 550 nm.

3. The transflective LCD device as claimed in claim 1, wherein the display panel further comprises an insulating layer located between the first electrode and the second electrode to electrically insulating the first electrode and the second electrode.

4. The transflective LCD device as claimed in claim 3, wherein one of the first electrode and the second electrode is an electrode with plural strips.

5. The transflective LCD device as claimed in claim 4, wherein an absolute value of an angle included between the strips and directors of the liquid crystal molecules near the first substrate is 0°˜10°.

6. The transflective LCD device as claimed in claim 4, wherein the display panel includes a reflective area with the reflective layer disposed on the first substrate and a transmissive area without the reflective layer disposed on the first substrate.

7. The transflective LCD device as claimed in claim 6, wherein a distance between edges of adjacent strips in the reflective area is different from that between edges of adjacent strips in the transmissive area.

8. The transflective LCD device as claimed in claim 7, wherein a distance between edges of adjacent strips in the reflective area is larger than that between edges of adjacent strips in the transmissive area.

9. The transflective LCD device as claimed in claim 1, wherein both the first electrode and the second electrode are electrodes with plural strips, and the strips of the first electrode and the strips of the second electrode are arranged alternately.

10. The transflective LCD device as claimed in claim 9, wherein an absolute value of an angle included between the strips and directors of the liquid crystal molecules is 0°˜10°.

11. The transflective LCD device as claimed in claim 9, wherein the display panel includes a reflective area with the reflective layer disposed on the first substrate and a transmissive area without the reflective layer disposed on the first substrate.

12. The transflective LCD device as claimed in claim 11, wherein a distance between edges of adjacent strips in the reflective area is different from that between edges of adjacent strips in the transmissive area.

13. The transflective LCD device as claimed in claim 12, wherein a distance between edges of adjacent strips in the reflective area is larger than that between edges of adjacent strips in the transmissive area.

14. The transflective LCD device as claimed in claim 1, further comprising a first retarder disposed above the second substrate, wherein a first alignment layer is disposed between the second electrode and the liquid crystal layer, an absolute value of an included angle between a rubbing direction of the first alignment layer and a slow axis of the first retarder is 70°˜110°, and the first retarder has a retardation of 110 nm˜160 nm at a wavelength of 550 nm.

15. The transflective LCD device as claimed in claim 1, further comprising a first polarizer disposed above the second substrate, wherein a first alignment layer is disposed between the second electrode and the liquid crystal layer, and an absolute value of an included angle between a rubbing direction of the first alignment layer and an absorption axis of the first polarizer is 80°˜140°.

16. The transflective LCD device as claimed in claim 1, further comprising a second polarizer and a second retarder disposed under the first substrate in which the second retarder is disposed between the first substrate and the second polarizer, wherein the second polarizer is a linear polarizer, the second retarder is a quarter wave plate with a retardation of 110 nm˜160 nm at a wavelength of 550 nm, and an included angle between a slow axis of the second retarder and an absorption axis of the second polarizer is 45°.

17. The transflective LCD device as claimed in claim 1, further comprising a wide band circular polarizer disposed under the first substrate.

18. The transflective LCD device as claimed in claim 1, wherein chiral dopant is further included in the liquid crystal layer.
